(19) United States
(12) Patent Application Publication
(10) Pub. No.: US 2021/0401100 A1
(43) Pub. Date: Dec. 30, 2021

(54) APPAREL AND ACCOUTREMENTS WITH PROTECTIVE ENHANCEMENTS

(71) Applicant: Karim W. Sadik, Horseheads, NY (US)

(72) Inventor: Karim W. Sadik, Horseheads, NY (US)

(21) Appl. No.: 17/095,279

(22) Filed: Nov. 11, 2020

Related U.S. Application Data
(60) Provisional application No. 62/705,488, filed on Jun. 30, 2020.
(60) Provisional application No. 62/705,962, filed on Jul. 24, 2020.
(60) Provisional application No. 62/705,964, filed on Jul. 24, 2020.
(60) Provisional application No. 62/705,965, filed on Jul. 24, 2020.
(60) Provisional application No. 62/706,680, filed on Sep. 2, 2020.
(60) Provisional application No. 62/706,669, filed on Sep. 2, 2020.

(51) Int. Cl. A41D 31/30; A44C 15/00; A41D 13/11; A62B 18/02; A62B 23/02; B05B 11/00

(52) U.S. Cl. CPC A41D 31/30; A44C 15/003; B05B 11/0005; A62B 18/025; A62B 23/025; A41D 13/1161

(57) ABSTRACT

Accessories are provided including jewelry and apparel. In particular, a fabric accessory for at least a neck region of a user includes a textile element configured to at least partially cover the neck region of the user, the textile element having a first width at a first height and a second width at a second height, a filter portion disposed within the textile element and configured to receive a filter for filtering respiratory air, and at least one fastener configured to fasten the textile element to a facial region of the user such that the filter portion at least partially covers a mouth and nose region of the user. The fabric accessory may have a variety of configurations including as fashion apparel, for example, a scarf or necktie.

### CROSS-REFERENCE TO RELATED APPLICATIONS

The present application claims priority to U.S. Provisional Patent Application No. 62/705,488 filed Jun. 30, 2020, U.S. Provisional Patent Application No. 62/705,962 filed Jul. 24, 2020, U.S. Provisional Patent Application No. 62/705,964 filed Jul. 24, 2020, U.S. Provisional Patent Application No. 62/705,965 filed Jul. 24, 2020, U.S. Provisional Patent Application No. 62/706,669 filed Sep. 2, 2020, and U.S. Provisional Patent Application No. 62/706,680 filed Sep. 2, 2020, the entire contents of which are incorporated herein by reference.

### FIELD

The present disclosure relates generally to the field of personal protective equipment (PPE).

### BACKGROUND

Personal protective equipment (PPE) is worn by professionals and laypeople for a variety of purposes, including health-related purposes. Surgical and cloth masks for reducing the transmission of airborne pathogens are examples of PPE.

### SUMMARY

In various circumstances, a user may desire to have the user's PPE readily available while nonetheless being able to refrain from covering a facial and/or neck region of the user with the PPE until desired. In some circumstances, a user may have an item of apparel, an accoutrement or accessory which may or may not at least partially cover the user's face and/or neck that is provided for a purpose other than PPE. Such apparel, accoutrements or accessories may be provided with enhancements according to one or more embodiments set forth herein, so as to facilitate providing PPE capability.

In particular, certain embodiments relate to a fabric accessory for at least a neck region of a user including a textile element configured to at least partially cover the neck region of the user, the textile element having a first width at a first height and a second width at a second height, a filter portion disposed within the textile element and configured to receive a filter for filtering respiratory air, and at least one fastener configured to fasten the textile element to a facial region of the user such that the filter portion at least partially covers a mouth and nose region of the user. The fabric accessory may be a tie or scarf.

In some embodiments, the textile element tapers from the first width to the second width, the first width being at an end of the textile element proximate the facial region, the second width being at an end of the textile element distal to the facial region. In some embodiments, the fabric accessory further includes a semi-rigid shape element coupled to the textile element and configured to hold at least a portion of the textile element in a position. In some embodiments, the filter portion is a pocket within the textile element, and wherein the textile element includes an aperture allowing access to the filter portion. In some embodiments, at least one fastener includes an elastic band configured to fasten to at least one ear of the user. In some embodiments, the filter portion at least partially seals the mouth and nose region of the user from an exterior region.

Another embodiment relates to a clothing accessory including a textile element configured to at least partially cover a head region of a user, a pocket positioned within a portion of the textile element configured to at least partially cover the head region of the user, a fastener positioned on the textile element, and a filter element configured to receive a filter and further configured to extend from the pocket to the fastener when in use, wherein when in use the filter at least partially covers a mouth and nose region of the user, and wherein when not in use the filter element is storable within the pocket.

In some embodiments, the clothing accessory is a hooded sweatshirt. In some embodiments, the pocket further includes a binding element configured to close an opening of the pocket. In some embodiments, the binding element is a zipper. In some embodiments, the filter couples within a pocket of the filter element. In some embodiments, the filter element at least partially seals the mouth and nose region of the user from an exterior region.

Another embodiment relates to a jewelry accessory including a band configured to couple around an appendage of a user, a reservoir disposed at least partially within the band and configured to hold a sanitizing fluid, and a cap coupled to the band and covering a dispensing mechanism, wherein the dispensing mechanism is configured to dispense the sanitizing fluid from the reservoir.

In some embodiments, the jewelry accessory is a bracelet. In some embodiments, the jewelry accessory is a ring. In some embodiments, the reservoir is positioned with a hollow portion of the band. In some embodiments, the dispensing mechanism is a spray nozzle configured to at least partially atomize the sanitizing fluid. In some embodiments, the cap is coupled to the band via a hinge. In some embodiments, the band is constructed from a compressible material and wherein compressing the band causes the dispensing mechanism to dispense the sanitizing fluid. In some embodiments, the band includes a sealable aperture configured to allow the reservoir to be filled with the sanitizing fluid.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a facemask, according to an exemplary embodiment.

FIG. 2 is a perspective view of another facemask, according to an exemplary embodiment.

FIG. 3 is a front view of a clothing item with an integrated facial covering, according to an exemplary embodiment.

FIG. 4 is a front view of the clothing item of FIG. 3 with the integrated facial covering in use, according to an exemplary embodiment.

FIG. 5 is another front view of the clothing item of FIG. 3 with the integrated facial covering in use, according to an exemplary embodiment.

FIG. 6 is a front view of an accessory with an integrated facial covering, according to an exemplary embodiment.

FIG. 7 is a front view of the accessory of FIG. 6 with the integrated facial covering opened for use, according to an exemplary embodiment.

FIG. 8 is a front view of the accessory of FIG. 6 with the integrated facial covering in use, according to an exemplary embodiment.

FIG. 9 is a front view of the accessory of FIG. 6 with the integrated facial covering being stored for future use, according to an exemplary embodiment.

FIG. 10 is a perspective view of a pacifier with an integrated facial covering, according to an exemplary embodiment.

FIG. 11 is a front view of the pacifier of FIG. 10 with the integrated facial covering in use, according to an exemplary embodiment.

FIG. 12 is a front view of a scarf with an integrated filter, according to an exemplary embodiment.

FIG. 13 is a front view of the integrated filter of FIG. 12, according to an exemplary embodiment.

FIG. 14 is a front view of the scarf with integrated filter of FIG. 14 in use, according to an exemplary embodiment.

FIG. 15 is a front view of a necktie with an integrated filter, according to an exemplary embodiment.

FIG. 16 is a back view of the necktie of FIG. 15, according to an exemplary embodiment.

FIG. 17 is a back view of the necktie of FIG. 15 in an expanded configuration, according to an exemplary embodiment.

FIG. 18 is a side view of the necktie with the integrated filter of FIG. 15 in use, according to an exemplary embodiment.

FIG. 19 is a front view of the necktie with the integrated filter of FIG. 15 in use, according to an exemplary embodiment.

FIG. 20 is a front view of a sanitizing bracelet, according to an exemplary embodiment.

FIG. 21 is a top view of the sanitizing bracelet of FIG. 20 with dispensing mechanism exposed, according to an exemplary embodiment.

FIG. 22 is a top view of the sanitizing bracelet of FIG. 20 in use, according to an exemplary embodiment.

FIG. 23 is a perspective view of the layers of a filter for use with any of the facial coverings of the present disclosure, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to several exemplary embodiments, apparel and accoutrements with protective enhancements are disclosed herein. In some embodiments, the apparel and accoutrements are configured to include a facial covering such as a facemask. For example, a necktie may include a filter and elastic bands to couple the filter to a facial region of a user. In particular, modifications to apparel and accoutrements may be provided for providing protection against airborne pathogens according to various embodiments. In various embodiments, apparel and accoutrements of the present disclosure may include a facemask. For example, a hooded sweatshirt may include a pocket containing a facemask that may be worn by a user when needed. In various embodiments, facemasks are integrated in apparel and/or accoutrements to facilitate easy carrying thereof and convenient application of facial coverings.

The apparel and accoutrements of the present disclosure may offer benefits over existing elements (e.g., facemasks, apparel, accessories, etc.). For example, in some contexts (e.g., such as during the shifts worked by office workers, during air transit, etc.), users may be required to wear a facial covering which may be difficult to keep track of or maintain in a relatively accessible and convenient location. Apparel and accoutrements according to the present disclosure may facilitate easily concealing a facial covering on one's person while permitting ready access to that facial covering. In particular, a facial covering may be integrated into a user's apparel and/or accessories to ensure that the facial covering is available when needed or desired. In particular, the facial covering may be maintained in a location that allows a user to avoid placing the mask on an external surface, thereby lowering the risk of further contamination.

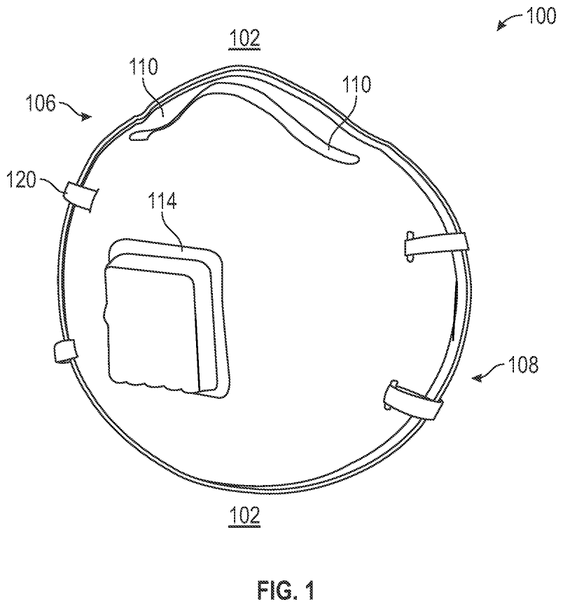

Referring now to FIG. 1, a front perspective view of a respirator, shown as mask 100 is shown, according to an exemplary embodiment. In various embodiments, mask 100 prevent particle droplets from contacting a user's mouth and/or nose region and/or filter inhaled air to remove airborne contaminants (e.g., aerosolized bacteria, viruses, etc.). Mask 100 may be used in healthcare environments (e.g., hospitals, nursing homes, etc.) and/or non-healthcare environments (e.g., by individuals in public spaces, etc.). In various embodiments, mask 100 includes top 102 and bottom 104. In various embodiments, during use top 102 may be positioned substantially over a user's nose (e.g., resting upon the nasal bridge, etc.). In various embodiments, during use bottom 104 may be positioned substantially under a user's chin (e.g., resting upon an upper neck region, etc.).

In various embodiments, mask 100 has a shape and size to facilitate covering a mouth and/or nose region of a user. However, it should be understood that mask 100 may have many shapes and/or sizes that facilitate covering a mouth and/or nose region of a user (e.g., to accommodate all shapes and sizes of faces) and that all such embodiments are within the scope of the present disclosure. Mask 100 may include front side 106 and back side 108. Mask 100 may include protective element 110 and earloops 120. Mask 100 may include straps for the user to tie or clip rather than earloops.

Protective element 110 may create a physical barrier between a mouth and/or nose region of a user and an external region. In various embodiments, protective element 110 is gas permeable to facilitate user breathing. In various embodiments, protective element 110 is selectively permeable to facilitate filtering respiratory air. For example, protective element 110 may allow respiratory gasses (e.g., nitrogen, oxygen, carbon dioxide, etc.) to pass through protective element 110 but may prevent (e.g., filter, etc.) various contaminants (e.g., germs, bacteria, viruses, harmful particulate matter, harmful gasses, etc.) from passing through protective element 110. In various embodiments, protective element 110 may filter 95% or greater of particles sized 0.3 microns from inhaled air. The protective element may filter greater than 95% of particles larger than 0.3 microns from inhaled air (e.g., 99.5% of particles 0.75 microns and larger, etc.).

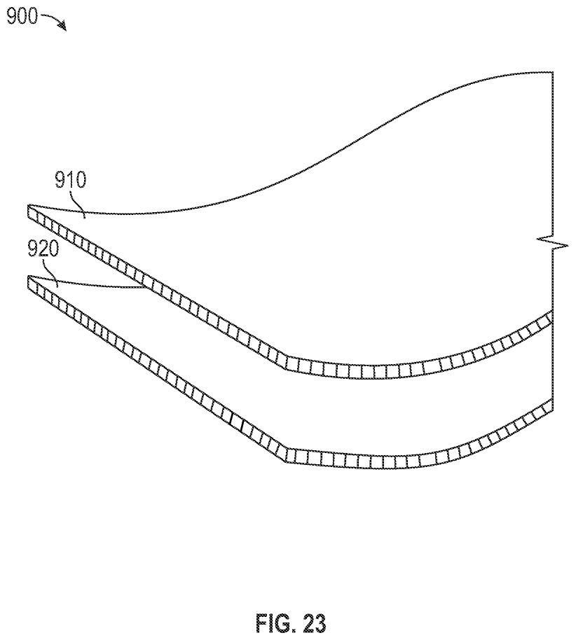

In various embodiments, protective element 110 is or includes a textile material. For example, protective element 110 may be made of a cotton material. As another example, protective element 110 may be made of a paper material. In various embodiments, protective element 110 includes multiple materials. For example, protective element 110 may include a first layer made of a non-woven fabric, a second layer made of a melt-blown material, and a third layer made of a non-woven fabric. The material composition of mask 100 is discussed in detail below with reference to FIG. 23.

Protective element 110 may include shape element 112 and valve 114. Shape element 112 may facilitate adjusting a shape of protective element 110. In various embodiments, shape element 112 includes semi-rigid elements. For example, shape element 112 may include a malleable metallic or composite strip that a user may manipulate to adjust a shape of protective element 110. In some embodiments, shape element 112 may facilitate creating at least partial seal between a top portion of protective element 110 and a user's face (e.g., a seal along a nasal bridge of a user, etc.).

Valve 114 may facilitate an exchange of gas (e.g., ambient air, etc.) between an interior region and an exterior region of mask 100. For example, valve 114 may facilitate releasing air exhaled by a user into an interior region of mask 100 to an exterior region of mask 100. Additionally or alternatively, valve 114 may facilitate permitting air inhaled by a user into an interior region of mask 100 from an exterior region of mask 100. In various embodiments, valve 114 is a one-way valve.

Earloops 120 may be coupled to protective element 110 and facilitate application of protective element 110 to a facial region of a user. In various embodiments, earloops 120 facilitate positioning protective element 110 such that protective element 110 forms a complete seal between a mouth and/or nose region of a user and an exterior region. In various embodiments, during use, a user positions earloops 120 behind his/her ears to secure mask 100. In some embodiments, mask 100 includes a chemical cartridge and/or canister to facilitate air filtering.

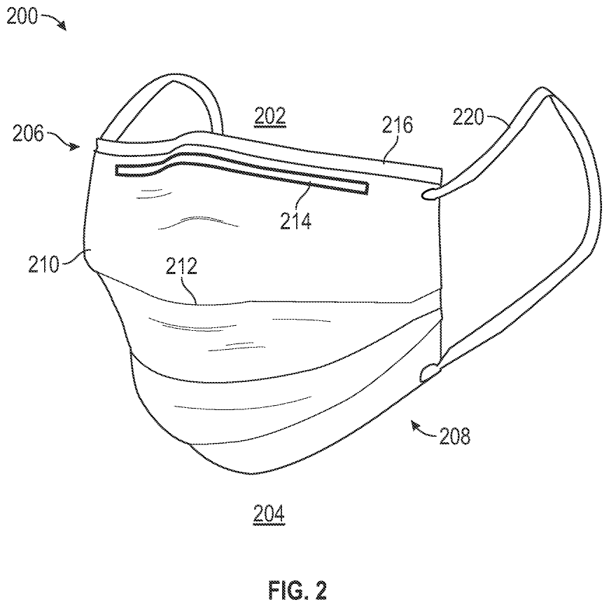

Referring now to FIG. 2, a front perspective view of a surgical mask, shown as mask 200 is shown, according to an exemplary embodiment. In various embodiments, mask 200 may prevent particle droplets from contacting a user's mouth and/or nose region and/or filter inhaled air to remove airborne contaminants (e.g., aerosolized bacteria, viruses, etc.). Mask 200 may be used in healthcare environments (e.g., hospitals, nursing homes, etc.) and/or non-healthcare environments (e.g., by individuals in public spaces, etc.). In various embodiments, mask 200 includes top 202 and bottom 204. In various embodiments, during use top 202 may be positioned substantially over a user's nose (e.g., resting upon the nasal bridge, etc.). In various embodiments, during use bottom 204 may be positioned substantially under a user's chin (e.g., resting upon an upper neck region, etc.).

In various embodiments, mask 200 has a shape and size to facilitate covering a mouth and/or nose region of a user. However, it should be understood that mask 200 may have many shapes and/or sizes that facilitate covering a mouth and/or nose region of a user (e.g., to accommodate most shapes and sizes of faces) and that all such embodiments are within the scope of the present disclosure. Mask 200 may include front side 206 and back side 208. Mask 200 may include protective element 210 and earloops 220.

Protective element 210 may create a physical barrier between a mouth and/or nose region of a user and an external region. In various embodiments, protective element 210 is gas permeable to facilitate user breathing. In various embodiments, protective element 210 is selectively permeable to facilitate filtering respiratory air. For example, protective element 210 may allow respiratory gas (e.g., nitrogen, oxygen, carbon dioxide, etc. and combinations thereof) to pass through protective element 210 but may prevent (e.g., filter, etc.) various contaminants (e.g., germs, bacteria, viruses, harmful particulate matter, harmful gasses, etc.) from passing through protective element 210.

In various embodiments, protective element 210 is or includes a textile material. For example, protective element 210 may be made of a cotton material. As another example, protective element 210 may be made of a paper material. In various embodiments, protective element 210 includes multiple materials. For example, protective element 210 may include a first layer made of a non-woven fabric, a second layer made of a melt-blown material, and a third layer made of a non-woven fabric. The material composition of mask 200 is discussed in detail below with reference to FIG. 24.

Protective element 210 may include folds 212 and shape elements 214 and 216. Folds 212 may facilitate loosely forming protective element 210 to a user's face. For example, folds 212 may facilitate deformation of protective element 210 to enable mask 200 to be worn by a user with a large nose. Shape elements 214 and/or 216 may facilitate adjusting a shape of protective element 210. In various embodiments, shape elements 214 and/or 216 include semi-rigid elements. For example, shape elements 214 and/or 216 may include a malleable metallic strip that a user may manipulate to adjust a shape of protective element 210. In some embodiments, shape elements 214 and/or 216 may facilitate creating at least a partial seal between a top portion of protective element 210 and a user's face (e.g., a partial seal along a nasal bridge of a user, etc.).

Earloops 220 may be coupled to protective element 210 and facilitate application of protective element 210 to a facial region of a user. In various embodiments, earloops 220 facilitate positioning protective element 210 such that protective element 210 forms at least a partial seal between a mouth and/or nose region of a user and an exterior region. In various embodiments, during use, a user positions earloops 220 behind his/her ears to secure mask 200. In some embodiments, mask 200 includes a chemical cartridge and/or canister to facilitate air filtering.

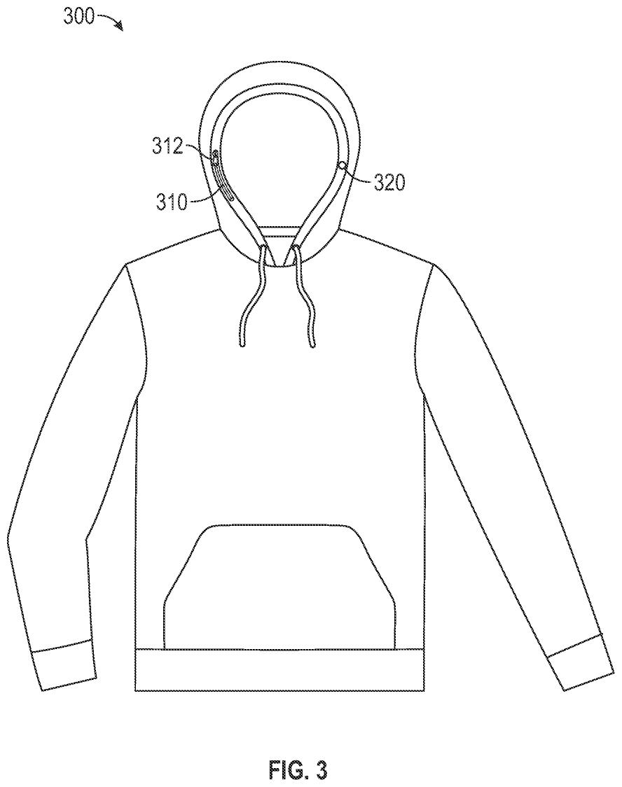

Referring now to FIGS. 3-5, clothing item 300 is shown, according to an exemplary embodiment. In various embodiments, clothing item 300 is a clothing item having a hood. For example, clothing item 300 may be a hooded sweatshirt, a hooded jacket, a hooded coat, a cowl, a hijab, a balaclava, a burqini, a headscarf, a hat, and/or the like. In various embodiments, clothing item 300 includes a facial covering such as a mask. For example, clothing item 300 may integrate mask 100 and/or mask 200. Additionally or alternatively, clothing item 300 may include a facial covering having a pocket to receive a filter. For example, a filter section may be cut from a traditional facemask (e.g., mask 100, mask 200, etc.) and inserted into the pocket of the facial covering for use with clothing item 300. In some embodiments, a filter pad or filter insert that is a commercially available product (e.g., a disposable filter pad or insert which is not cut from a mask) is provided in the pocket 310. In some embodiments, the user may insert and/or replace disposable filters as the user desires. Clothing item 300 is shown to include pocket 310, and attachment 320. Accordingly, the clothing item 300 provides ready access to mask 100 or mask 200 which is available, for example, in the event that the user loses or cannot instantly access another mask (external to clothing item 300). The mask 100 or 200 does not need to be carried separately, and is available as being integrated in clothing item 300 which avoids the need to search for an external mask, and reduces the exposure time (the time until the user's facial region is covered by the mask) in the event that there is sudden proximity to another or to a crowd of people, for example.

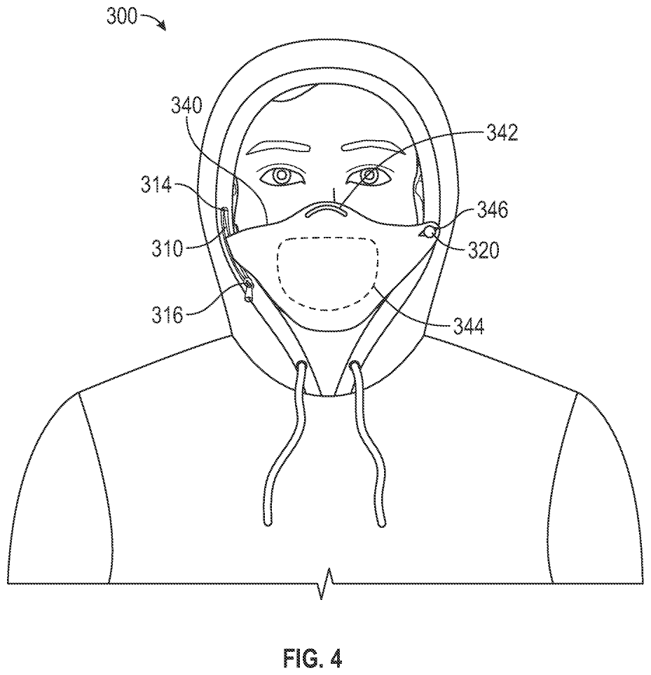

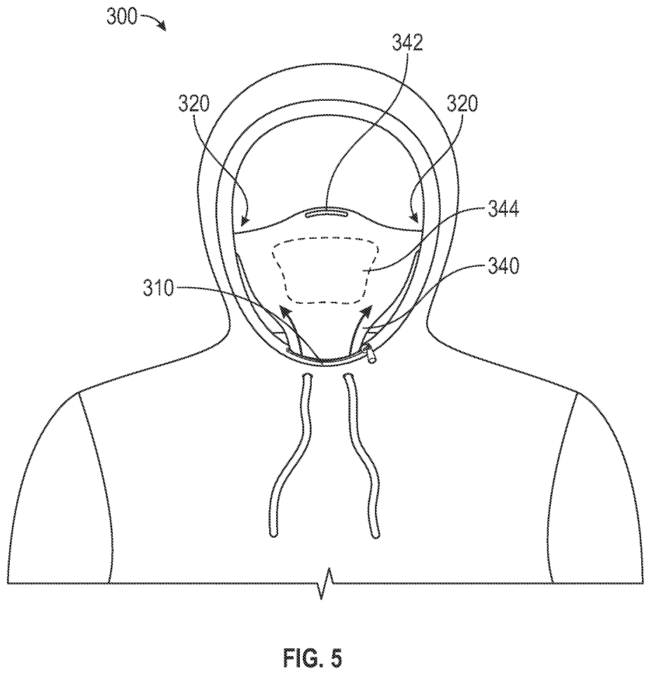

Pocket 310 may be a pocket within clothing item 300. For example, pocket 310 may be located on a hood section of clothing item 300. In various embodiments, pocket 310 is located on a side of a hood of clothing item 300 (e.g., as in FIGS. 3-4). Additionally or alternatively, pocket 310 may be located on a collar portion of clothing item 300 (e.g., as in FIG. 5). In various embodiments, pocket 310 stores a facial covering such as a facemask. Pocket 310 may include an outside portion and an inside portion. The outside portion may include an opening (e.g., an aperture or slit, etc.) to facilitate access to the inside portion. In various embodiments, pocket 310 includes a binding element (a bind or binder), shown as zipper 312. Zipper 312 may close the opening of pocket 310 and secure contents (e.g., a facial covering, etc.) within pocket 310. In some embodiments, clothing item 300 does not include a binding element such as zipper 312 and an opening of pocket 310 may be left at least partially open.

Pocket 310 may store (house) facial covering 340. In some embodiments, facial covering 340 is at least partially coupled to clothing item 300. For example, a side of facial covering 340 may be coupled to clothing item 300 (e.g., within an inside portion of pocket 310, via an elastic band/tether, etc.). Additionally or alternatively, facial covering 340 may be separate of clothing item 300. In some embodiments, facial covering 340 is detachably coupled to clothing item 300. For example, facial covering 340 may include a button to couple facial covering 340 to clothing item 300. In various embodiments, facial covering 340 extends out from pocket 310 to cover a mouth and/or nose region of a user. For example, facial covering 340 may extend out horizontally from pocket 310 to span a hood opening and attach to attachment 320 (e.g., as shown in FIG. 4).

Additionally or alternatively, facial covering 340 may extend out vertically from pocket 310 and attach on either side of a hood opening (e.g., as shown in FIG. 5). Attachment 320 may include a button or other fastening element (e.g., snap fastener, magnet, etc.). In various embodiments, attachment 320 is positioned on an inside of a hood of clothing item 300. Additionally or alternatively, attachment 320 may be positioned on another surface of clothing item 300 (e.g., an outside surface of a hood of clothing item 300, etc.). In some embodiments, multiple attachments 320 exist. For example, attachments 320 may be positioned on the inside surface of both sides of a hood opening (e.g., as shown in FIG. 5). In various embodiments, facial covering 340 couples to attachment 320. For example, facial covering 340 may include a fastener, shown as button hole 346. Additionally or alternatively, button hole 346 may include a loop such as an elastic loop to facilitate fastening facial covering 340 to attachment 320. However it should be understood that the fastener may take various forms such as a snap fastener, a hook-and-eye, a magnet, a hook-and-loop (e.g., Velcro®, etc.), a zipper, and/or the like. In various embodiments, zipper 312 moves between a first position 314 (e.g., a closed position) and a second position 316 (e.g., an open position). Second position 316 may allow facial covering 340 to extend out from pocket 310.

Facial covering 340 may create a physical barrier between a mouth and/or nose region of a user and an external region. In various embodiments, facial covering 340 is gas permeable to facilitate user breathing. In various embodiments, facial covering 340 is selectively permeable to facilitate filtering respiratory air. In some embodiments, facial covering 340 is constructed of a textile material. For example, facial covering 340 may be constructed from several layers of a cotton material. As an additional example, facial covering 340 may be constructed at least partially of polyester with embedded nylon to facilitate sealing facial covering 340 to a user's face. In some embodiments, facial covering 340 is stored within pocket 310 in a collapsed configuration (e.g., folded, etc.) to save space. When in use, facial covering 340 may be unfurled to cover a user's mouth and/or nose region. In some embodiments, facial covering 340 includes one or more earloops. For example, facial covering 340 may include earloops to secure facial covering 340 to a user's face.

Facial covering 340 is shown to include shape element 342 and filter pocket 344. Shape element 342 may facilitate adjusting a shape of facial covering 340. In various embodiments, shape element 342 includes semi-rigid elements. For example, shape element 342 may include a malleable metallic strip that a user may manipulate to adjust a shape of facial covering 340. In some embodiments, shape element 342 may facilitate creating at least a partial seal between a top portion of facial covering 340 and a user's face (e.g., a partial seal along a nasal bridge of a user, etc.).

Filter pocket 344 may receive a filter. For example, filter pocket 344 may receive a N-95 filter to filter respiratory air and facilitate reducing the spread of pathogens. In various embodiments, the filter is gas permeable to facilitate user breathing. In various embodiments, the filter is selectively permeable to facilitate filtering respiratory air. For example, the filter may allow respiratory gas (e.g., nitrogen, oxygen, carbon dioxide, etc. and combinations thereof) to pass through the filter but may prevent (e.g., filter, etc.) various contaminants (e.g., germs, bacteria, viruses, harmful particulate matter, harmful gasses, etc.) from passing through the filter. In some embodiments, facial covering 340 at least partially integrates mask 100 and/or mask 200. For example, a portion of mask 100 may be cut off to fit in filter pocket 344 and filter a user's respiratory air. As an additional example, filter pocket 344 may facilitate inserting mask 100 and/or mask 200 into facial covering 340. In various embodiments, filter pocket 344 is sized to at least partially cover a mouth and/or nose region of a user. In various embodiments, an opening of filter pocket 344 is located on an inside of facial covering 340 (e.g., a side facing a user's face, etc.). In some embodiments, an opening of filter pocket 344 includes a fastener (e.g., Velcro, etc.) to secure a filter within filter pocket 344.

In various embodiments, the filter is or includes a textile material. For example, the filter may be made of a cotton material. As another example, the filter may be made of a paper material. In various embodiments, the filter includes multiple materials. For example, the filter may include a first layer made of a non-woven fabric, a second layer made of a melt-blown material, and a third layer made of a non-woven fabric.

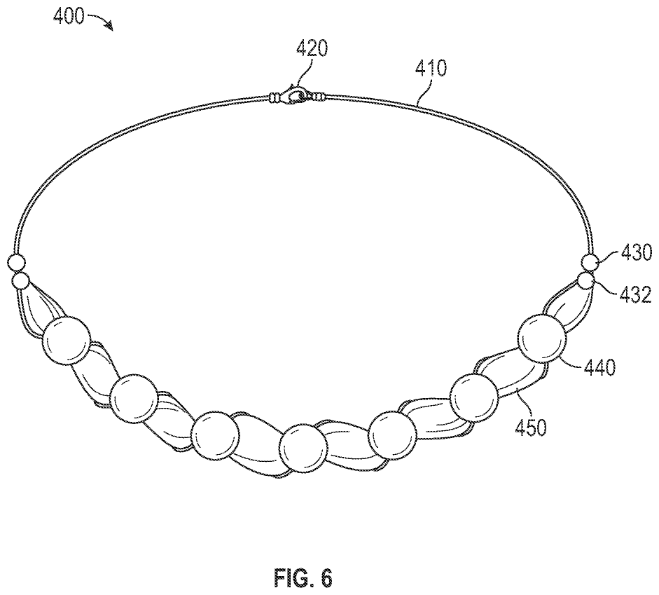

Referring now to FIGS. 6-9, accessory 400 is shown, according to an exemplary embodiment. Accessory 400 may be a necklace, neck ring, brooch, choker, pendant, lanyard, and/or the like. In some embodiments, accessory 400 is or includes jewelry. For example, in some embodiments, the jewelry may be in the form of a brooch that may be pinned to an article of clothing. In various embodiments, accessory 400 includes a facial covering such as mask 100 and/or mask 200. In various embodiments, accessory 400 is configured to be worn around a neck of a user. Accessory 400 includes band 410, fastening mechanism 420, attachment 430, beads 440, and facial covering 450. Band 410 may be configured to wrap around a user's neck. Band 410 may be constructed of various materials such as metal, polymer, woven textiles, and/or the like. Fastening mechanism 420 may include clasp 422 and loop 424. Thus, in such embodiments, the mask 100 or 200 does not need to be carried, located and retrieved like an external mask, and is available as being integrated in accessory 400. Such integration avoids the need to search for an external mask, and reduces the exposure time (the time until the user's facial region is covered by the mask), including, for example, when an external mask is lost or cannot be readily located or when the user suddenly is in proximity to another person or to a crowd.

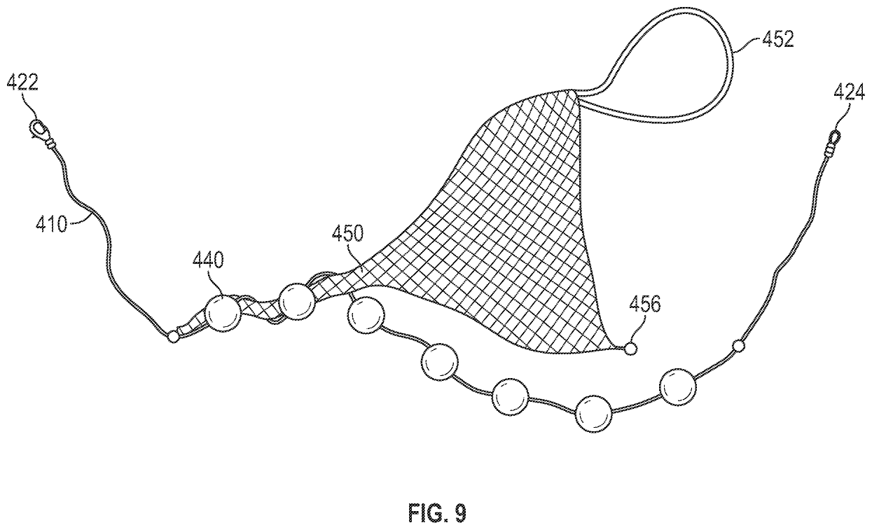

Attachment 430 may be configured to couple facial covering 450 to accessory 400. For example, attachment 430 may magnetically couple to a portion of facial covering 450. In some embodiments, attachment 430 includes a clasp and/or clasp loop. Beads 440 may facilitate wrapping facial covering 450 around band 410 (e.g., as shown in FIG. 9). For example, facial covering 450 may be wound around band 410 using beads 440 to hold facial covering 450 in place. Beads 440 may be constructed of and/or include various materials such as polymer, semiprecious stone, metals, composite materials, metallic fibers, wood, and/or the like. In various embodiments, beads 440 provide aesthetic embellishment to accessory 400.

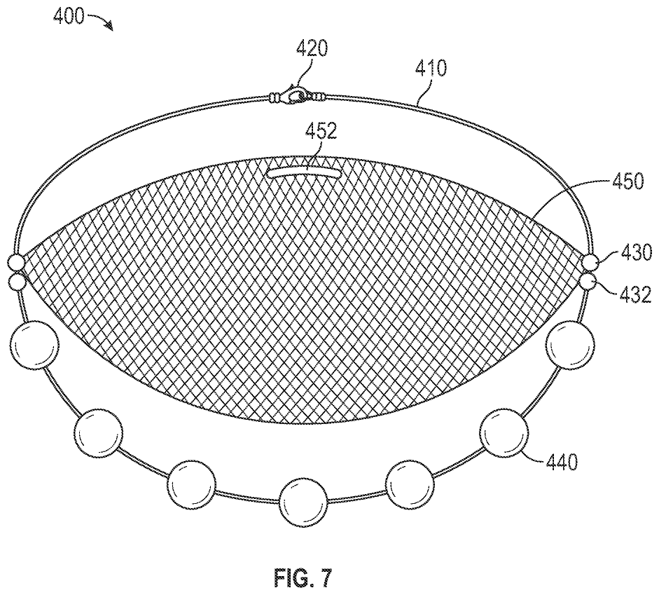

In various embodiments, facial covering 450 may be unwound from band 410 (e.g., as shown in FIG. 7, etc.). Facial covering 450 may create a physical barrier between a mouth and/or nose region of a user and an external region. In various embodiments, facial covering 450 is gas permeable to facilitate user breathing. In various embodiments, facial covering 450 is selectively permeable to facilitate filtering respiratory air. In some embodiments, facial covering 450 is constructed of a textile material. For example, facial covering 450 may be constructed from several layers of a cotton material. As an additional example, facial covering 450 may be constructed at least partially of polyester with embedded nylon to facilitate sealing facial covering 450 to a user's face. In some embodiments, facial covering 450 at least partially integrates aspects of other facial coverings disclosed herein. For example, facial covering 450 may be or include elements of mask 100 and/or mask 200. In some embodiments, facial covering 450 includes a pocket to receive a filter.

Facial covering 450 is shown to include earloops 452, shape element 454, and fastener 456. Earloops 452 may be coupled to facial covering 450 and facilitate application of facial covering 450 to a facial region of a user. In various embodiments, earloops 452 facilitate positioning facial covering 450 such that facial covering 450 forms at least a partial seal between a mouth and/or nose region of a user and an exterior region. In various embodiments, during use, a user positions earloops 452 behind his/her ears to secure facial covering 450. Shape element 454 may facilitate adjusting a shape of facial covering 450. In various embodiments, shape element 454 includes semi-rigid elements. For example, shape element 454 may include a malleable metallic strip that a user may manipulate to adjust a shape of facial covering 450. In some embodiments, shape element 454 may facilitate creating at least a partial seal between a top portion of facial covering 450 and a user's face (e.g., a partial seal along a nasal bridge of a user, etc.).

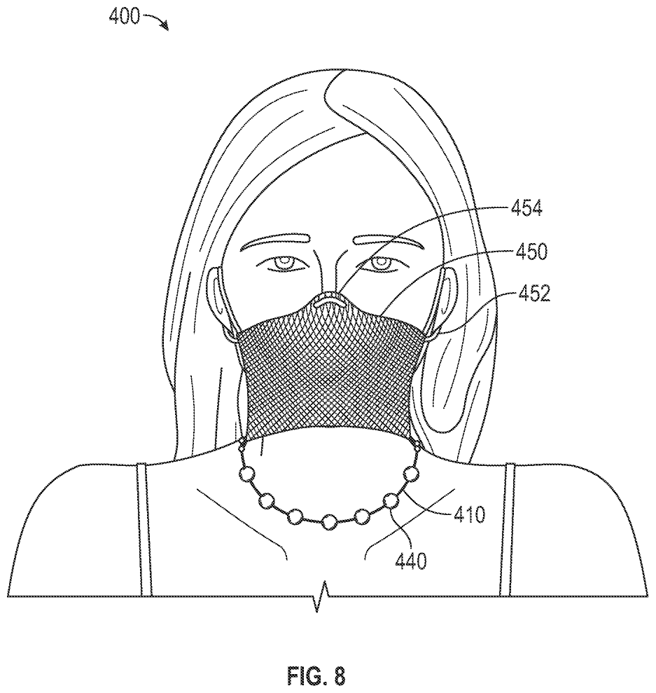

Fastener 456 may facilitate fastening facial covering 450 to band 410. In various embodiments, fastener 456 couples to attachment 430. For example, fastener 456 may magnetically couple to attachment 430. In some embodiments, fastener 456 includes a clasp and/or a clasp loop. In various embodiments, facial covering 450 includes a number of fasteners 456. For example, facial covering 450 may include a fastener 456 at bottom corners of facial covering 450 to facilitate covering a user's mouth and/or nose region during use (e.g., as shown in FIG. 8).

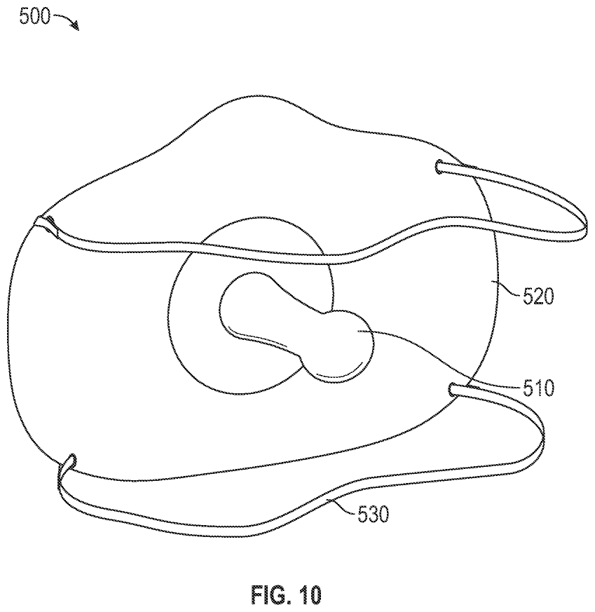

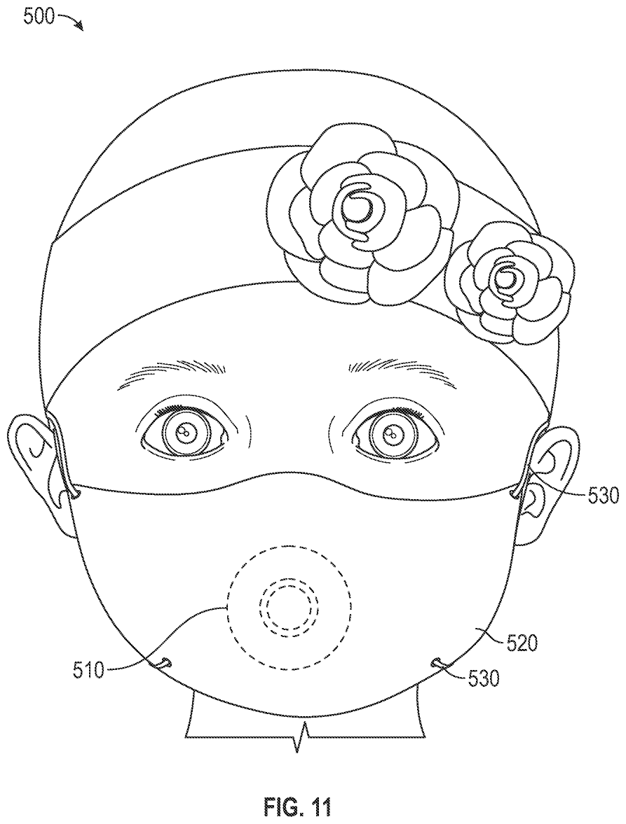

Referring now to FIGS. 10-11, pacifier mask 500 is shown, according to an exemplary embodiment. In various embodiments, pacifier mask 500 is usable by infants, babies, and/or small children to reduce the spread of infectious pathogens. Pacifier mask 500 includes pacifier 510, mask 520, and earloops 530. Pacifier 510 may be a nipple substitute configured to quiet user distress and/or satisfy the user's need to suck (e.g., to satisfy a rooting reflex, etc.). Pacifier 510 may be constructed of rubber, plastic, silicone, and/or the like. In some embodiments, pacifier 510 includes an aperture to facilitate a user to breathe through their mouth while pacifier 510 is in their mouth. In various embodiments, pacifier 510 is detachably coupled to mask 520. The pacifier 510 may incentivize an infant or toddler to wear the mask 520, with the pacifier 510 being comfortably accessible while the infant or toddler is wearing the mask, thus promoting higher compliance in mask-wearing among this age cohort as compared to masks without such pacifiers, and may also be worn for significantly longer times.

Mask 520 may create a physical barrier between a mouth and/or nose region of a user and an external region. In various embodiments, mask 520 is gas permeable to facilitate user breathing. In various embodiments, mask 520 is selectively permeable to facilitate filtering respiratory air. In some embodiments, mask 520 is constructed of a textile material. For example, mask 520 may be constructed from several layers of a cotton material. As an additional example, mask 520 may be constructed at least partially of polyester with embedded nylon to facilitate sealing mask 520 to a user's face. In some embodiments, mask 520 at least partially integrates aspects of other facial coverings disclosed herein. For example, mask 520 may include a pocket to receive a filter. In various embodiments, mask 520 is one of mask 100 and/or mask 200.

Earloops 530 facilitates positioning mask 520 such that mask 520 forms at least a partial seal between a mouth and/or nose region of a user and an exterior region. In various embodiments, during use, earloops 530 are positioned around a head and/or neck region of a user. For example, a first one of earloops 530 may be positioned around the back of a user's neck and a second one of earloops 530 may be positioned around the back of a user's head. In various embodiments, earloops 530 are nylon.

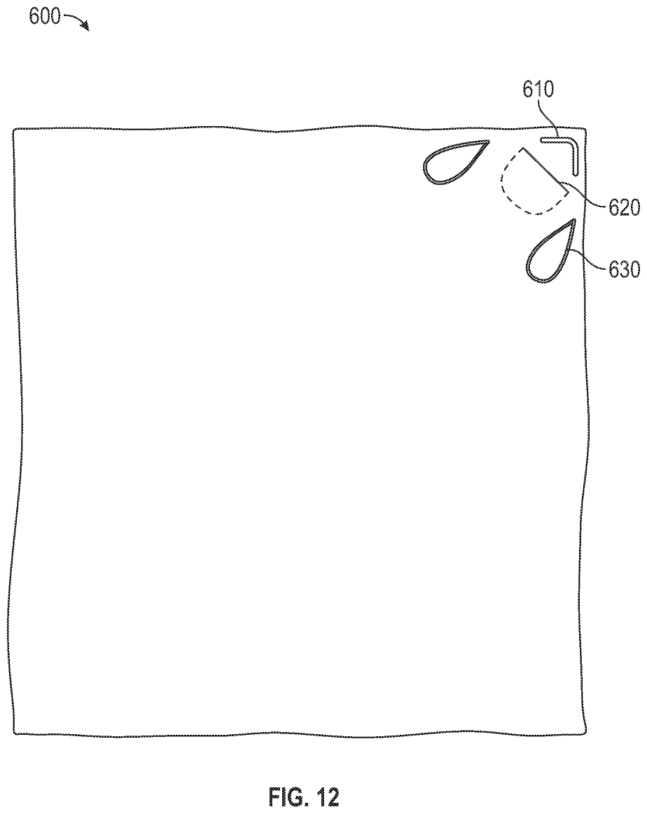

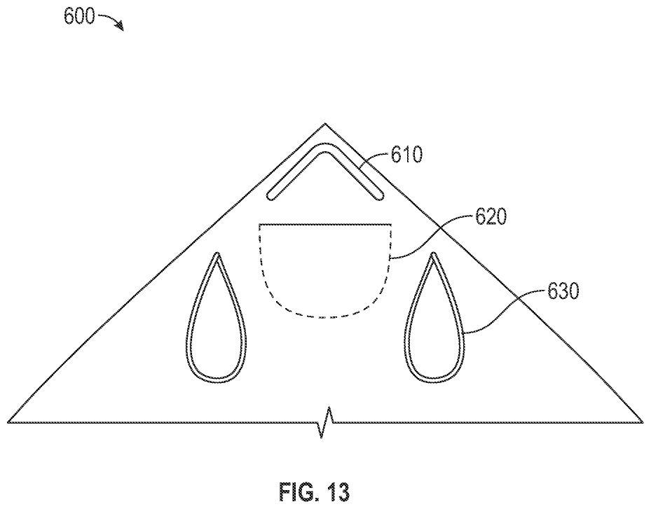

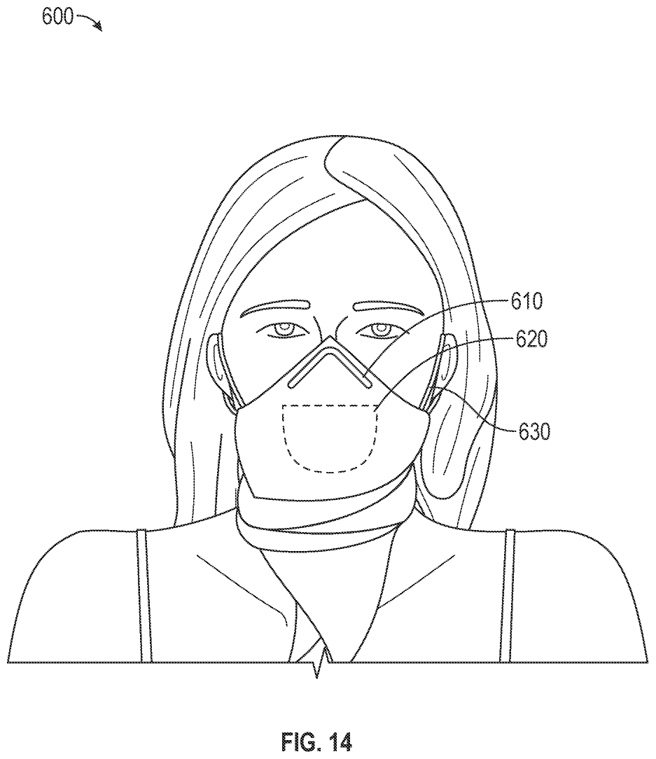

Referring now to FIGS. 12-14, scarf 600 is shown, according to an exemplary embodiment. Scarf 600 may be a fabric article configured to be worn around a user's head and/or neck. In various embodiments, scarf 600 is substantially square shaped (e.g., diamond shaped). Additionally or alternatively, scarf 600 may be substantially rectangular shaped. Scarf 600 may be made of various materials such as woven textiles such as cotton, cashmere, silk, and/or the like. In various embodiments, in use, scarf 600 is wrapped around a head and/or neck of a user (e.g., as shown in FIG. 14). Scarf 600 may include shape element 610, filter pocket 620, and earholes 630. Shape element 610 may facilitate adjusting a shape of scarf 600. In various embodiments, shape element 610 includes semi-rigid elements. For example, shape element 610 may include a malleable metallic strip that a user may manipulate to adjust a shape of scarf 600. In some embodiments, shape element 610 may facilitate creating at least a partial seal between a top portion of scarf 600 and a user's face (e.g., a partial seal along a nasal bridge of a user, etc.). The scarf 600 provides ready access to mask 100 or 200, as discussed below, in a manner that reduces exposure time that may otherwise occur if the user were searching for an external mask (e.g., if the user suddenly came into proximity with another person or a crowd).

Filter pocket 620 may receive a filter. For example, filter pocket 620 may receive an N-95 filter to filter respiratory air and facilitate reducing the spread of pathogens. In various embodiments, the filter is gas permeable to facilitate user breathing. In various embodiments, the filter is selectively permeable to facilitate filtering respiratory air. For example, the filter may allow respiratory gas (e.g., nitrogen, oxygen, carbon dioxide, etc. and combinations thereof) to pass through the filter but may prevent (e.g., filter, etc.) various contaminants (e.g., germs, bacteria, viruses, harmful particulate matter, harmful gasses, etc.) from passing through the filter. In some embodiments, filter pocket 620 at least partially integrates mask 100 and/or mask 200. For example, a portion of mask 100 may be cut off to fit in filter pocket 620 and filter a user's respiratory air. As an additional example, filter pocket 620 may facilitate inserting mask 100 and/or mask 200 into scarf 600. In various embodiments, filter pocket 620 is sized to at least partially cover a mouth and/or nose region of a user. In various embodiments, an opening of filter pocket 620 is located on an inside of scarf 600 (e.g., a side facing a user's face, etc.). In some embodiments, an opening of filter pocket 620 includes a fastener (e.g., Velcro®, etc.) to secure a filter within filter pocket 620. In various embodiments, the opening to filter pocket 620 is located on a top of filter pocket 620 to facilitate securing a filter within filter pocket 620 when oriented correctly.

Earholes 630 may be configured to facilitate securing scarf 600 to a user's mouth and/or nose region. In various embodiments, earholes 630 facilitate positioning scarf 600 such that filter pocket 620 forms at least a partial seal between a mouth and/or nose region of a user and an exterior region. In various embodiments, during use, a user positions the user's ears through earholes 630 to secure scarf 600. In various embodiments, earholes 630 include an aperture through scarf 600. In some embodiments, earholes 630 include elastic. For example, earholes 630 may include elastic inlaid around a perimeter of the hole.

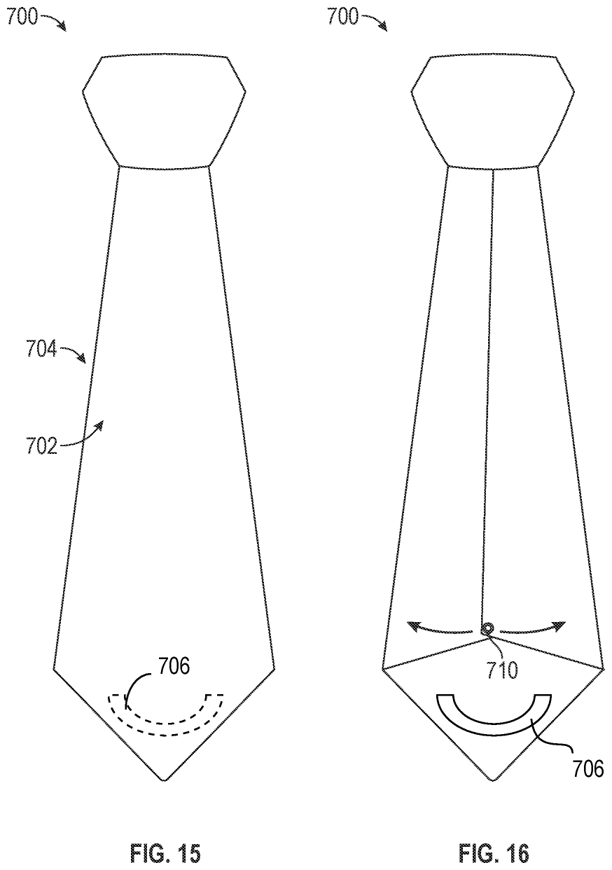

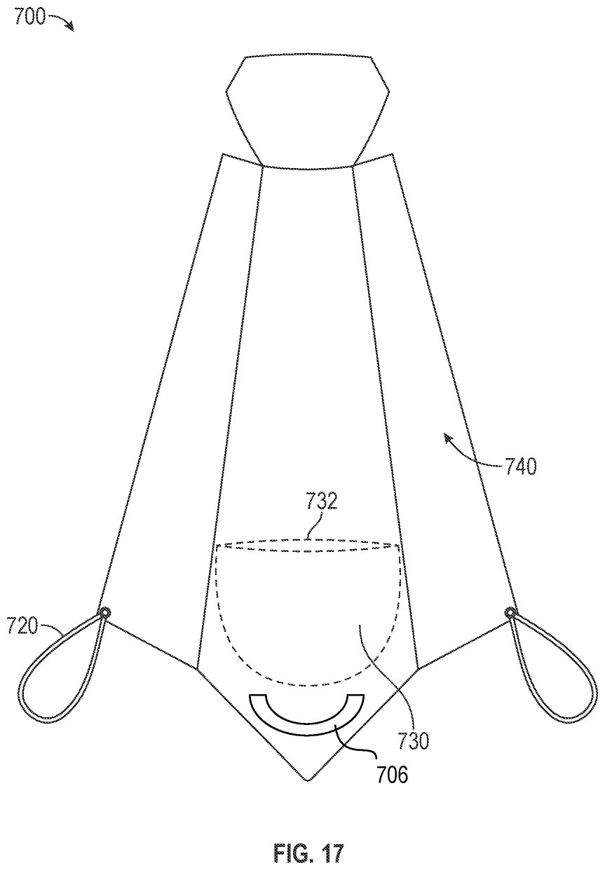

Referring now to FIG. 15-19, necktie 700 is shown, according to an exemplary embodiment. Necktie 700 may be configured to be worn around a neck of a user. In various embodiments, necktie 700 integrates a facemask such as mask 100 and/or mask 200. Necktie 700 includes front side 702 and backside 704. Backside 704 is shown to include fastener 710. Fastener 710 is configured to fasten panels 740 in a closed configuration. While in a closed configuration, panels 740 may be configured to take on the form of necktie 700 (e.g., as shown in FIG. 16). While in an open configuration, panels 740 may reveal filter pocket 730 (e.g., as shown in FIG. 17).

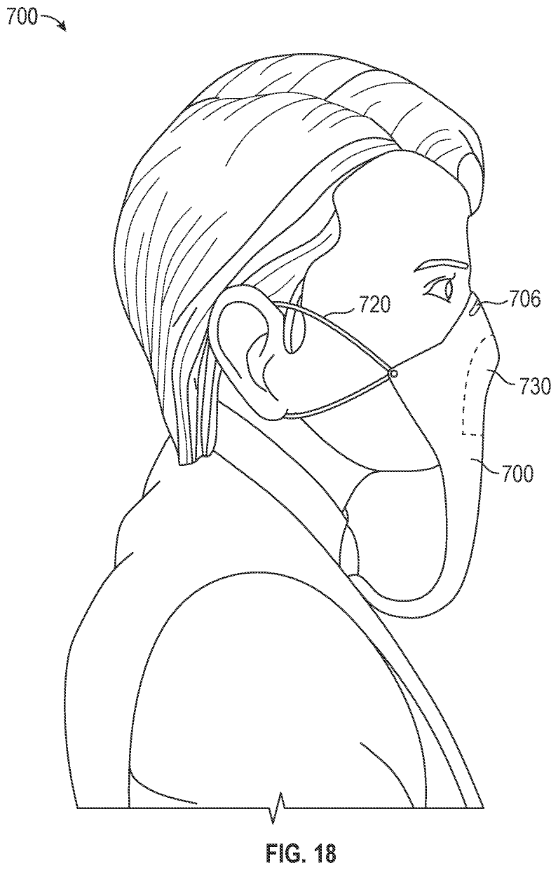

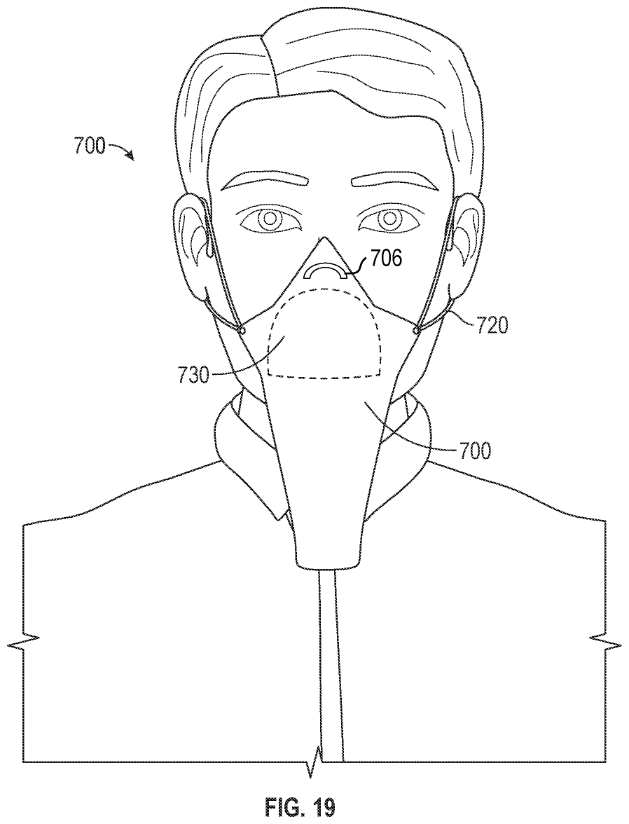

Necktie 700 may be worn as a facemask by lifting a bottom portion of necktie 700 (e.g., when worn as a standard necktie, etc.) and securing it to a user's face (e.g., as shown in FIGS. 18-19). Necktie 700 may include shape element 706, earloops 720, filter pocket 730, and panels 740. The necktie 700 provides ready access to mask 100 or 200, as discussed below, in a manner that may reduce exposure time that may otherwise occur if the user were searching for an external mask (e.g., if the user suddenly came into proximity with another person or a crowd, for example, when on public transportation). Providing in situ access to the mask 100 or 200 may be particularly preferable in the event the user is on public transportation or in another environment where the presence of others may be unpredictable and change suddenly.

Shape element 706 may facilitate adjusting a shape of necktie 700. In various embodiments, shape element 706 includes semi-rigid elements. For example, shape element 706 may include a malleable metallic or composite strip that a user may manipulate to adjust a shape of necktie 700. In some embodiments, shape element 706 may facilitate creating at least partial seal between a top portion of necktie 700 and a user's face (e.g., a seal along a nasal bridge of a user, etc.).

Earloops 720 facilitates positioning necktie 700 such that filter pocket 730 forms at least a partial seal between a mouth and/or nose region of a user and an exterior region. In various embodiments, during use, a user positions earloops 720 behind his/her ears to secure necktie 700 to a facial region. In various embodiments, earloops 720 are nylon.

Filter pocket 730 may receive a filter. For example, filter pocket 730 may receive an N-95 filter to filter respiratory air and facilitate reducing the spread of pathogens. In various embodiments, the filter is gas permeable to facilitate user breathing. In various embodiments, the filter is selectively permeable to facilitate filtering respiratory air. For example, the filter may allow respiratory gas (e.g., nitrogen, oxygen, carbon dioxide, etc. and combinations thereof) to pass through the filter but may prevent (e.g., filter, etc.) various contaminants (e.g., germs, bacteria, viruses, harmful particulate matter, harmful gasses, etc.) from passing through the filter. In some embodiments, filter pocket 730 at least partially integrates mask 100 and/or mask 200. For example, a portion of mask 100 may be cut off to fit in filter pocket 730 and filter a user's respiratory air. As an additional example, filter pocket 730 may facilitate inserting mask 100 and/or mask 200 into necktie 700. In various embodiments, filter pocket 730 is sized to at least partially cover a mouth and/or nose region of a user. In various embodiments, filter pocket 730 includes opening 732. Opening 732 may facilitate inserting a filter (e.g., mask 100, mask 200, etc.) into filter pocket 730. In some embodiments, opening 732 includes a fastener (e.g., Velcro®, etc.) to secure a filter within filter pocket 730.

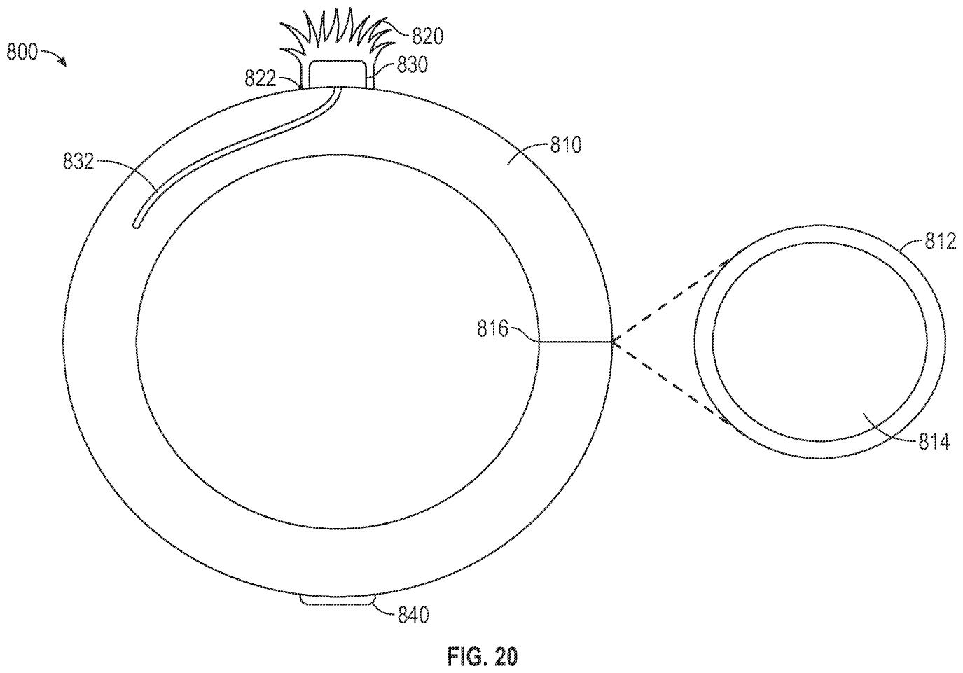

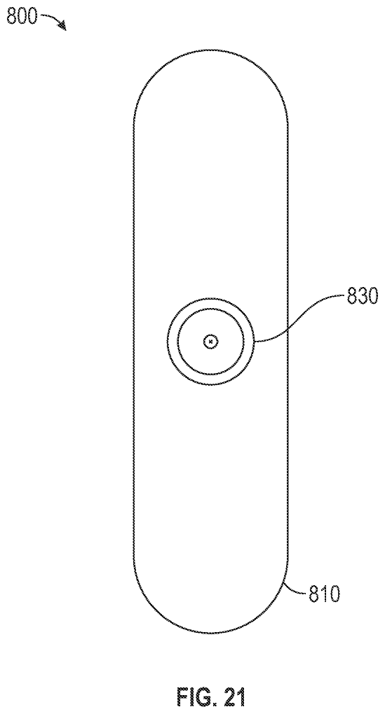

Referring now to FIGS. 20-22, sanitizing bracelet 800 is shown, according to an exemplary embodiment. Sanitizing bracelet 800 is configured to dispense sanitizing fluid for use in sanitizing surfaces such as a user's hands. The sanitizing bracelet 800 beneficially provides access to sanitizing fluid or gel stored therein, avoiding the need to search for a separate container of hand sanitizer (e.g., in a purse or pocket) where contact with various surfaces or objects may occur, and allows ready access to adults and children who wear sanitizing bracelet 800. In particular, the exemplary embodied sanitizing bracelet 800 allows for immediate access to the sanitizing fluid or gel on the user's person.

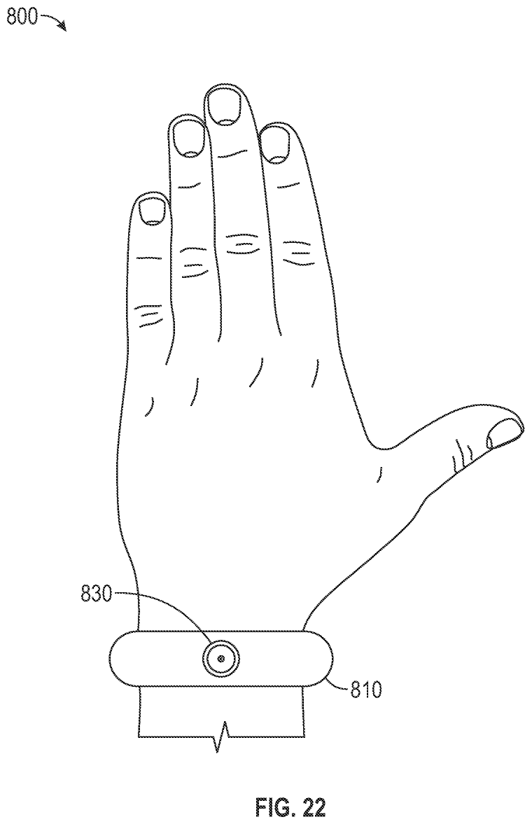

In various embodiments, sanitizing bracelet 800 is worn on a user's wrist (e.g., as shown in FIG. 22). Sanitizing bracelet 800 is shown to include band 810, cap 820, dispensing mechanism 830, and port 840. Band 810 may be a band configured to secure sanitizing bracelet 800 to a user's wrist. Band 810 may be made of various materials such as metals, alloys, plastic, wood, and/or the like. In various embodiments, band 810 is includes fastener 816. Fastener 816 may fasten ends of band 810 together and may facilitate putting on and/or taking off sanitizing bracelet 800 (e.g., from a user's wrist, etc.). In some embodiments, sanitizing bracelet 800 does not include fastener 816 (e.g., band 810 is an unbroken ring). In various embodiments, band 810 is hollow. For example, band 810 may be hollowed out to store a sanitizing fluid. Band 810 may include walls 812 and cavity 814. Cavity 814 may be a reservoir for a sanitizing fluid. Port 840 may facilitate refilling sanitizing bracelet 800 with sanitizing fluid or gel. For example, a user may remove a plug-in port 840 to reveal an aperture into cavity 814 that may be used to refill sanitizing bracelet 800 with sanitizing fluid. In various embodiments, port 840 is sealed to prevent the contents of cavity 814 from escaping through port 840.

Cap 820 may cover dispensing mechanism 830. In various embodiments, cap 820 is a decorative cap with ornamentally styling. For example, cap 820 may be styled as a gemstone to make sanitizing bracelet 800 more appealing as an object of jewelry to adorn the user. In various embodiments, cap 820 is coupled to band 810 via hinge 822. Hinge 822 may fasten cap 820 at one edge to allow cap 820 to tilt open to reveal dispensing mechanism 830. In some embodiments, cap 820 does not include hinge 822.

Dispensing mechanism 830 may dispense a fluid or gel from within sanitizing bracelet 800. For example, dispensing mechanism 830 may dispense hand-sanitizer. Dispensing mechanism 830 may be a spray nozzle, pump dispenser, port dispenser, pressure aperture, and/or the like. In some embodiments, band 810 is at least partially flexible/compressible, and compression (e.g., squeezing, etc.) of band 810 causes dispensing mechanism 830 to dispense sanitizing fluid or gel. In some embodiments, the band 810 may be squeezed when worn by a user or when removed off the user's person to dispense sanitizing fluid or gel. In various embodiments, dispensing mechanism 830 includes feed 832. Feed 832 may supply liquid from cavity 814. In various embodiments, feed 832 is a hollow plastic tube.

Referring now to FIG. 23, a perspective view illustrating layers 900 of various filters (e.g., mask 100, mask 200, etc.) are shown, according to an exemplary embodiment. In various embodiments, the apparel and/or accoutrements of the present disclosure include filters having first layer 910, second layer 920. Optionally, a third layer may be present. Additionally or alternatively, the apparel and/or accoutrements of the present disclosure may include a different number and or arrangement of layers 900 than described herein. For example, pacifier mask 500 may include between three to five layers 900. In various embodiments, first layer 910 is a non-woven layer. For example, first layer 910 may be made of a cloth-like filter material. Second layer 920 may be a filter material. For example, second layer 920 may be a melt-blown material, a spunbonded material, and/or the like. A third layer, not shown, may be a non-woven layer.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the facemasks disclosed herein and the components thereof as shown in the various exemplary embodiments are illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A fabric accessory for at least a neck region of a user, comprising:
a textile element configured to at least partially cover the neck region of the user, the textile element having a first width at a first height and a second width at a second height, the textile element tapering from the first width to the second width;
a filter portion disposed within the textile element and configured to receive a filter for filtering respiratory air; and
at least one fastener configured to fasten the textile element to a facial region of the user such that the filter portion at least partially covers a mouth and nose region of the user,
wherein the fabric accessory is configured as a scarf or a necktie.

2. The fabric accessory of claim 1, wherein the first width is at an end of the textile element proximate the facial region, the second width is at an end of the textile element distal to the facial region.

3. The fabric accessory of claim 1, further comprising a semi-rigid shape element coupled to the textile element and configured to hold at least a portion of the textile element in a position.

4. The fabric accessory of claim 1, wherein the filter portion is a pocket within the textile element, and wherein the textile element includes an aperture allowing access to the filter portion.

5. The fabric accessory of claim 1, wherein the at least one fastener includes an elastic band configured to fasten to at least one ear of the user.

6. The fabric accessory of claim 1, wherein the filter portion at least partially seals the mouth and nose region of the user from an exterior region.

7. A clothing accessory, comprising:
a textile element configured to at least partially cover a head region of a user;
a pocket positioned within a portion of the textile element configured to at least partially cover the head region of the user;
a fastener positioned on the textile element; and
a filter element configured to receive a filter and further configured to extend from the pocket to the fastener when in use, wherein when in use the filter at least partially covers a mouth and nose region of the user, and wherein when not in use the filter element is storable within the pocket.

8. The clothing accessory of claim 7, wherein the clothing accessory is a hooded sweatshirt.

9. The clothing accessory of claim 7, wherein the pocket further includes a binding element configured to close an opening of the pocket.

10. The clothing accessory of claim 9, wherein the binding element is a zipper.

11. The clothing accessory of claim 7, wherein the filter is configured to be coupled within a pocket of the filter element.

12. The clothing accessory of claim 7, wherein the filter element at least partially seals the mouth and nose region of the user from an exterior region.

13. A jewelry accessory, comprising:
a band configured to couple around an appendage of a user;
a reservoir disposed at least partially within the band and configured to hold a sanitizing fluid; and
a cap coupled to the band and covering a dispensing mechanism, wherein the dispensing mechanism is configured to dispense the sanitizing fluid from the reservoir.

14. The jewelry accessory of claim 13, wherein the jewelry accessory is a bracelet.

15. The jewelry accessory of claim 13, wherein the jewelry accessory is a ring.

16. The jewelry accessory of claim 13, wherein the reservoir is positioned with a hollow portion of the band.

17. The jewelry accessory of claim 13, wherein the dispensing mechanism is a spray nozzle configured to at least partially atomize the sanitizing fluid.

18. The jewelry accessory of claim 13, wherein the cap is coupled to the band via a hinge.

19. The jewelry accessory of claim 13, wherein the band is constructed from a compressible material and wherein the band is configured such that compression of the band causes the dispensing mechanism to dispense the sanitizing fluid.

20. The jewelry accessory of claim 13, wherein the band includes a sealable aperture configured to allow the reservoir to be filled with the sanitizing fluid.
